(19) United States
(12) Patent Application Publication
(10) Pub. No.: US 2026/0314563 A1
(43) Pub. Date: Oct. 15, 2026

(54) HANDHELD SOFT PET FOOD AND TREAT DISPENSER WITH REPLACEABLE POUCH SYSTEM

(71) Applicant: Zachary Tyler, Longmont, CO (US)

(72) Inventor: Zachary Tyler, Longmont, CO (US)

(21) Appl. No.: 19/573,390

(22) Filed: Mar. 20, 2026

Related U.S. Application Data
(60) Provisional application No. 63/774,820, filed on Mar. 20, 2025.

(51) Int. Cl. A01K 15/02

(52) U.S. Cl. CPC A01K 15/0201

(57) ABSTRACT

A handheld, hand-operated dispensing system for dispensing soft edibles and medications for pets having a reusable handheld dispenser body, including an internal chamber, a replaceable sealed, flexible pouch positioned in the chamber, the pouch containing soft pet food, soft pet treats, pastes, medications of a specific viscosity, pâté-like substances, or edible medication mixtures and a dispensing mechanism adapted to deliver a controlled portion thereof in indoor household environments and during outdoor field training and handling activities.

### CROSS-REFERENCE TO RELATED APPLICATIONS

This application claims priority to U.S. Provisional Patent Application Ser. No. 63/774,820 filed on Mar. 20, 2025, the entire contents of which are incorporated herein by reference.

### FIELD OF THE INVENTION

The present invention relates generally to systems for dispensing soft edibles and medications such as soft pet treats, pet food and veterinary medications. More specifically, the present invention relates to handheld, hand-operated pet food and treat dispensers. In particular, the present invention relates to handheld, hand-operated pet food and treat dispensers, intended for both personal and professional pet trainer and veterinarian use, the dispensers including a manual dispensing apparatus adapted to hold and operate a replaceable, sealed pouch system for safe, controlled and sanitary dispensing of soft edibles such as soft pet food, soft pet treats, pastes, pâté-like food substances and soft pet medications of various viscosities.

### BACKGROUND OF THE INVENTION

Existing methods for dispensing soft pet treats such as finger feeding, squeeze tubes, improvised containers and electrical or battery operated dispensing systems are messy, unhygienic, inconvenient, and difficult to use in domestic on-leash or professional field and hunting dog training sessions. Many existing solutions require two hands, lack portion control, create waste, and place the user's fingers close to an animal's mouth, thus enhancing the chance of being bitten.

Commercially available pet treat and pet food dispensing devices include soft pet treat squeeze tubes, baby food pouches, culinary piping bags such as the squeezable bags or cupcake syringes bakers use for cake decorating, and gravity-fed or electronically controlled feeder systems intended for home use. While these devices may dispense soft consumables, they present several challenges to use in all conceivable scenarios and are not purpose-built for safe and convenient, portion-controlled, refill-based, one-handed dispensing of soft pet treats, particularly during field training or handling activities. For example, existing systems such as squeeze pouches and packets require manual compression to deliver the contents, an imprecise method at best which more often than not leads to inconsistent portioning and messy delivery. As noted above, open-hand feeding increases the risk of accidental finger and hand bites, particularly when handling and training excited or aggressive dogs for police or personal protection work. Moreover, the retrieval of loose treats carried in bags or in a handler's or trainer's pockets often results in fumbling, broken treats and crumbs, delays in delivery which disrupt reward-based training, and can lead to food and clothing contamination. While mechanisms exist for dispensing soft foods and pastes in other industries, for example ice cream and yogurt dispensers, they have not been adapted for pet food applications which present precise portioning, ergonomic handling, safety, and hygiene considerations.

In view of the above, it is evident that a need exists for a handheld, hand-operated dispensing system capable of handling soft pet food, soft pet treats, pastes, pâté-like substances, and medications in both home use and in field handling and training scenarios and veterinary treatment applications. The present invention addresses aforementioned needs in the art as well as other needs, all of which will become apparent to those skilled in the art from the accompanying disclosure.

### SUMMARY OF THE INVENTION

In accordance with the embodiments of the present invention, a handheld, hand-operated dispensing system for dispensing soft edibles and medications is disclosed having a reusable handheld dispenser body including an internal cavity or chamber, a sealed, disposable flexible pouch positioned in the chamber, the pouch containing soft pet food, soft pet treats, pastes, medications of a specific viscosity, or pâté-like substances, and an actuating or dispensing mechanism adapted to deliver a controlled portion of the soft pet food, soft pet treats, pastes, medications of a specific viscosity, edible-medication mixtures, or pâté-like substances in indoor household environments and during outdoor field training and handling activities.

In an embodiment, a handheld, hand-operated dispensing system for dispensing soft edibles and medications includes a reusable handgun or pistol-shaped dispenser body having an elongated, rectangular-shaped upper body portion, including an internal cavity or chamber adapted to house a sealed, flexible pouch containing soft pet edibles or medications, the dispenser body and internal cavity or chamber extending coaxially along a longitudinal axis, and a handle or grip portion extending radially outward from the handgun or pistol-shaped dispenser body.

In another embodiment, a handheld, hand-operated dispensing system for dispensing soft edibles and medications includes a reusable handheld dispenser body in the shape of a cupcake syringe or a caulk gun.

In yet another embodiment, a handheld, hand-operated dispensing system for dispensing soft edibles and medications includes an ergonomic handle or grip portion contoured to fit a human hand.

In still another embodiment, a handheld, hand-operated dispensing system for dispensing soft edibles and medications includes an ergonomic handle or grip portion contoured to fit a human hand and having rubberized or textured surfaces for improved comfort and usability.

In another embodiment, an actuating or dispensing mechanism of a handheld, hand-operated dispensing system for dispensing soft edibles and medications is a friction-based clutch system.

In yet another embodiment, an actuating or dispensing mechanism of a handheld, hand-operated dispensing system for dispensing soft edibles and medications is a ratchet-and-pawl mechanism.

In still another embodiment, an actuating or dispensing mechanism of a handheld, hand-operated dispensing system for dispensing soft edibles and medications is an electrically powered lead screw system.

In another embodiment, an actuating or dispensing mechanism of a handheld, hand-operated dispensing system for dispensing soft edibles and medications is a slider-based advancement system.

In yet another embodiment, an actuating or dispensing mechanism of a handheld, hand-operated dispensing system for dispensing soft edibles and medications is a manual twist or lead screw based advancement system.

In another embodiment, an actuating or dispensing mechanism of a handheld, hand-operated dispensing system for dispensing soft edibles and medications is a roller-based compression system.

In still another embodiment, a handheld, hand-operated dispensing system for dispensing soft edibles and medications includes a nozzle or dispensing port structured and arranged to provide controlled dispensing of soft edibles and medications.

In yet another embodiment, a handheld, hand-operated dispensing system for dispensing soft edibles and medications includes a nozzle or dispensing port structured and arranged to provide controlled dispensing of soft edibles and medications, the nozzle or dispensing port further including interchangeable tip attachments.

In another embodiment, a handheld, hand-operated dispensing system for dispensing soft edibles and medications includes a sealed, flexible foil or plastic pouch adapted to store and dispense soft pet edibles, medications, or soft pet edible medication mixtures.

In still another embodiment, a handheld, hand-operated dispensing system for dispensing soft edibles and medications includes a heat-sealed, flexible foil or plastic pouch adapted to store and dispense soft pet edibles, medications, or soft pet edible medication mixtures, the pouch having a tear-off tip, a twist-off top, or a pre-cut opening for controlled dispensing of the soft pet edibles, medications, or soft pet edible medication mixtures contained therein.

In yet another embodiment, a handheld, hand-operated dispensing system for dispensing soft edibles and medications includes an integrated belt clip, holster attachment, or hand loop, enabling hands-free carrying during walking, outdoor training or outdoor activities.

These and other features, aspects and advantages of the present invention will become apparent to those skilled in the art from the following detailed description of preferred embodiments taken in connection with the accompanying drawings, which are summarized briefly below.

### BRIEF DESCRIPTION OF THE DRAWINGS

Referring now to the attached drawings which form a part of this original disclosure:

FIG. 1 is a top front perspective view of the handheld, hand-operated dispensing system for dispensing soft edibles and medications in accordance with an embodiment of the present invention;

FIG. 2 is a front side elevation view of the handheld, hand-operated dispensing system for dispensing soft edibles and medications of FIG. 1 in accordance with an embodiment of the present invention;

FIG. 3 is a rear side elevation view of the handheld, hand-operated dispensing system for dispensing soft edibles and medications of FIGS. 1 and 2 in accordance with an embodiment of the present invention;

FIG. 4 is a top plan view of the handheld, hand-operated dispensing system for dispensing soft edibles and medications of FIGS. 1-3 in accordance with an embodiment of the present invention;

FIG. 5 is a bottom plan view of the handheld, hand-operated dispensing system for dispensing soft edibles and medications of FIGS. 1-4 in accordance with an embodiment of the present invention;

FIG. 6 a left side elevation view of the handheld, hand-operated dispensing system for dispensing soft edibles and medications of FIGS. 1-5 in accordance with an embodiment of the present invention;

FIG. 7 is a right side elevation view of the handheld, hand-operated dispensing system for dispensing soft edibles and medications of FIGS. 1-6 in accordance with an embodiment of the present invention;

FIG. 8A is a front top perspective view of the handheld, hand-operated dispensing system for dispensing soft edibles and medications of FIGS. 1-7 with a side access door or panel in an open position in accordance with an embodiment of the present invention;

FIG. 8B is a front top perspective view of a sealed, flexible foil or plastic pouch adapted to store and dispense soft pet edibles, medications, or soft pet edible medication mixtures in accordance with an embodiment of the present invention;

FIG. 9 is a front elevation sectional view of the handheld, hand-operated dispensing system for dispensing soft edibles and medications of FIGS. 1-8A illustrating a manual plunger advancement mechanism in the form of a friction-based clutch system in accordance with an embodiment of the present invention;

FIG. 10 is a front elevation sectional view of the handheld, hand-operated dispensing system for dispensing soft edibles and medications of FIGS. 1-8A illustrating a manual plunger advancement mechanism in the form of a palm press assembly in accordance with an embodiment of the present invention;

FIG. 11 is a front elevation sectional view of the handheld, hand-operated dispensing system for dispensing soft edibles and medications of FIGS. 1-8A illustrating a manual plunger advancement mechanism in the form of a twist knob assembly in accordance with an embodiment of the present invention;

FIG. 12 is a front elevation sectional view of the handheld, hand-operated dispensing system for dispensing soft edibles and medications of FIGS. 1-8A illustrating a manual plunger advancement mechanism in the form of a ratchet and pawl assembly in accordance with an embodiment of the present invention;

FIG. 13 is a front elevation sectional view of the handheld, hand-operated dispensing system for dispensing soft edibles and medications of FIGS. 1-8A illustrating a manual plunger advancement mechanism in the form of an electrically powered lead screw system in accordance with an embodiment of the present invention;

FIG. 14 is an enlarged top front perspective view of a portion of the electrically powered lead screw system of FIG. 13 in accordance with an embodiment of the present invention;

FIG. 15A is a front elevation sectional view of the handheld, hand-operated dispensing system for dispensing soft edibles and medications of FIGS. 1-8A illustrating a manual plunger advancement mechanism in the form of a friction-based clutch system further including a roller-based pouch compression system in accordance with an embodiment of the present invention;

FIG. 15B is a top plan sectional view of the roller-based pouch compression system illustrated in FIG. 15A in accordance with an embodiment of the present invention;

FIG. 16 is a top front perspective view of the handheld, hand-operated dispensing system for dispensing soft edibles and medications having a cylindrically-shaped body and a manual plunger advancement mechanism in the form of a ratchet and pawl assembly n accordance with an embodiment of the present invention;

FIG. 17 is an exploded top front perspective view of the handheld, hand-operated dispensing system for dispensing soft edibles and medications shown in FIG. 16 in accordance with an embodiment of the present invention;

FIG. 18A is a side elevation sectional view of the handheld, hand-operated dispensing system for dispensing soft edibles and medications having a cylindrically-shaped body and a manual plunger advancement mechanism in the form of a slider-based mechanism in accordance with an embodiment of the present invention;

FIG. 18B is a top front partial sectional view of the handheld, hand-operated dispensing system for dispensing soft edibles and medications of FIG. 18A in accordance with an embodiment of the present invention;

FIG. 19 is a side elevation view of the handheld, hand-operated dispensing system for dispensing soft edibles and medications having a cylindrically-shaped body and a side access aperture in accordance with an embodiment of the present invention;

FIG. 20 is an exploded top front perspective view of the handheld, hand-operated dispensing system for dispensing soft edibles and medications shown in FIG. 19 in accordance with an embodiment of the present invention;

FIG. 21 is a top right front perspective view of the handheld, hand-operated dispensing system for dispensing soft edibles and medications having a thumb-actuated advancement mechanism in accordance with an embodiment of the present invention;

FIG. 22 is a side elevation sectional view of the handheld, hand-operated dispensing system for dispensing soft edibles and medications of FIG. 21 having a thumb-actuated ratchet advancement mechanism in accordance with an embodiment of the present invention;

FIG. 23 is a side elevation sectional view of the handheld, hand-operated dispensing system for dispensing soft edibles and medications of FIG. 21 having a thumb-actuated electrically powered advancement mechanism in accordance with an embodiment of the present invention;

FIG. 24 is a top plan view of the palm press-actuated handheld, hand-operated dispensing system for dispensing soft edibles and medications in accordance with an embodiment of the present invention;

FIG. 25 is a partial sectional top perspective view of the palm press-actuated handheld, hand-operated dispensing system for dispensing soft edibles and medications of FIG. 24 illustrating portions of the internal operating mechanism thereof in accordance with an embodiment of the present invention; and

FIG. 26 is an exploded perspective view of the palm press-actuated handheld, hand-operated dispensing system depicted in FIGS. 24 and 25.

### DETAILED DESCRIPTION OF THE PREFERRED EMBODIMENTS

Selected embodiments of the present invention will now be explained with reference to the drawings. It will be apparent to those skilled in the art from this disclosure that the following descriptions of the embodiments of the present invention are provided for illustration only and not for the purpose of limiting the invention as defined by the appended claim and its equivalents.

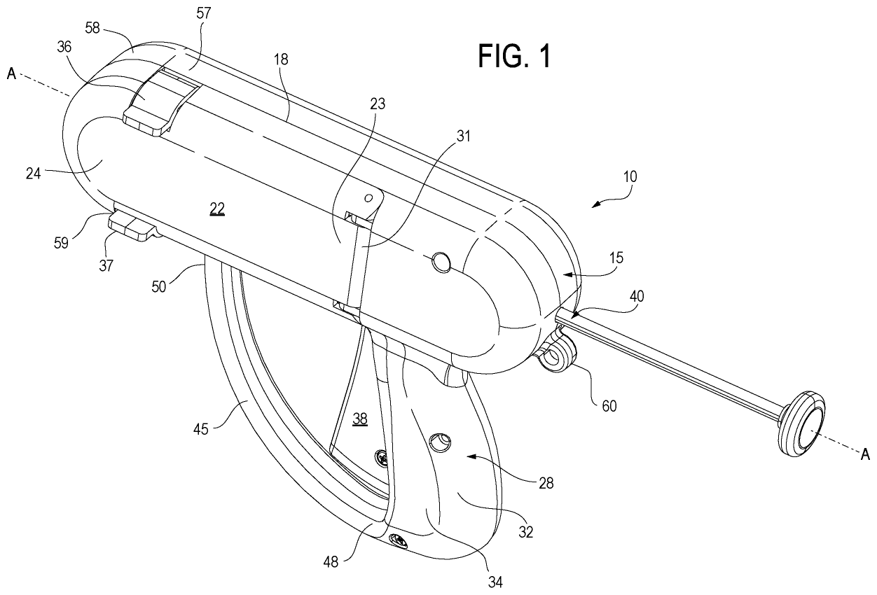

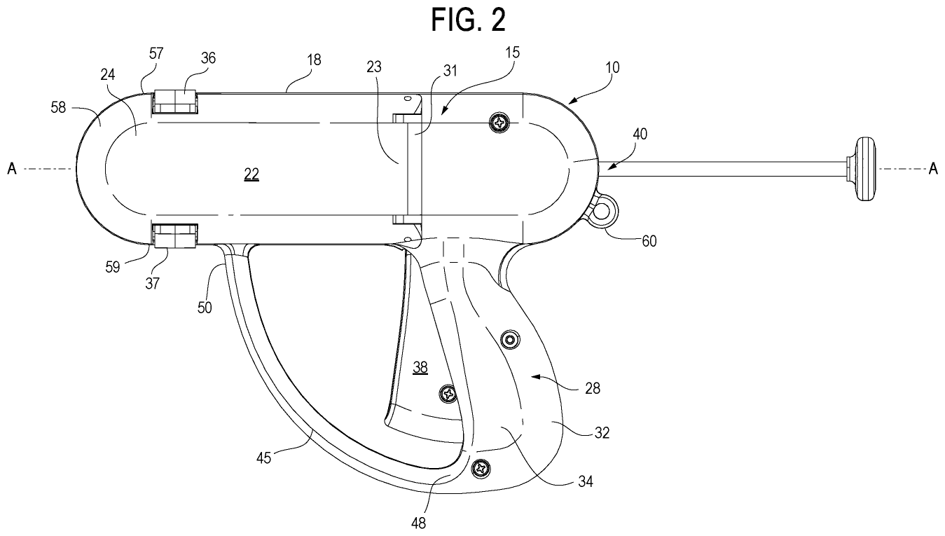

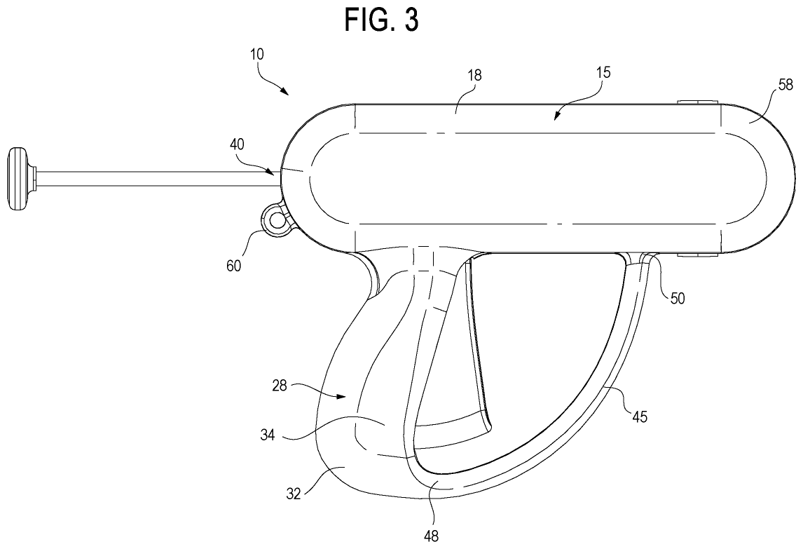

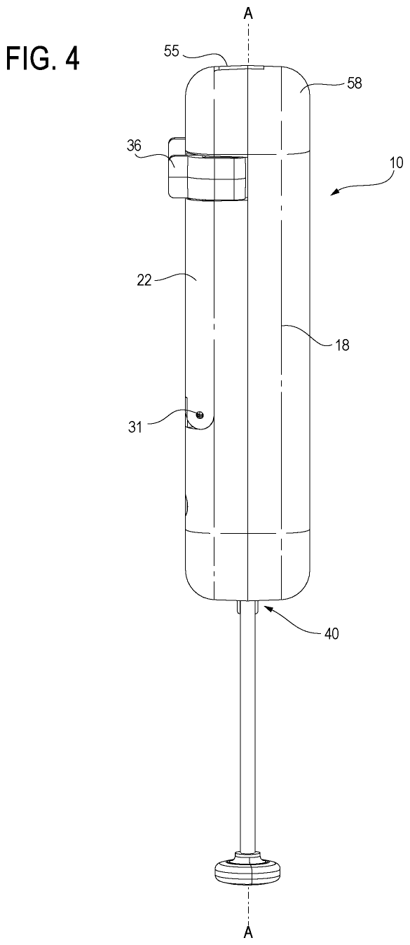

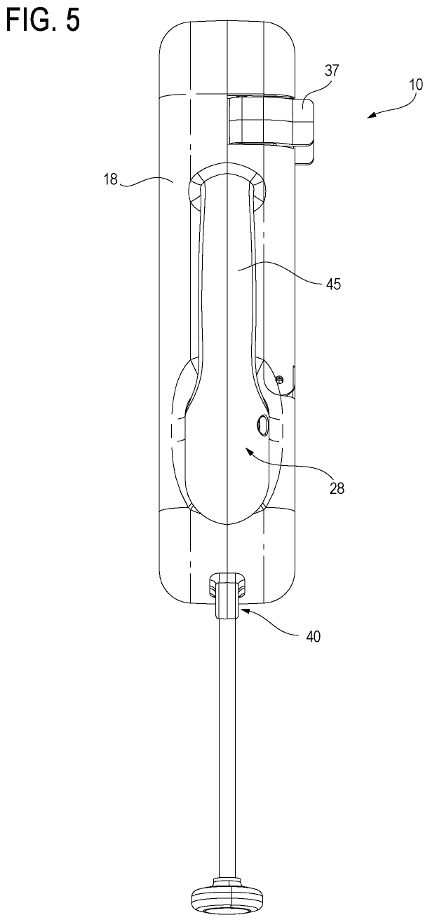

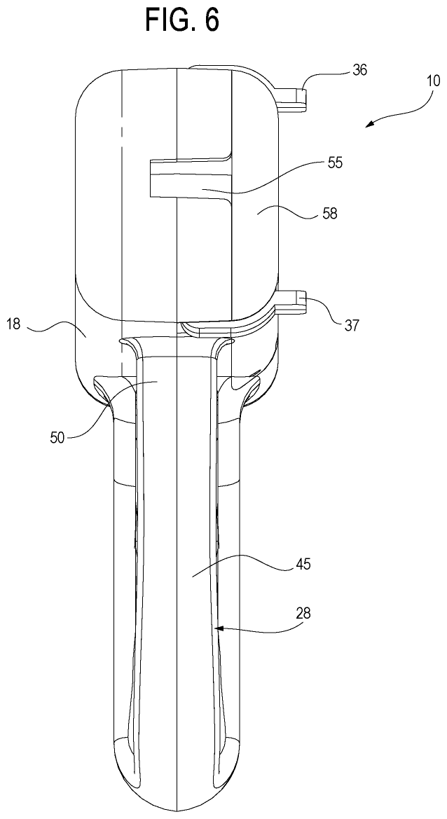

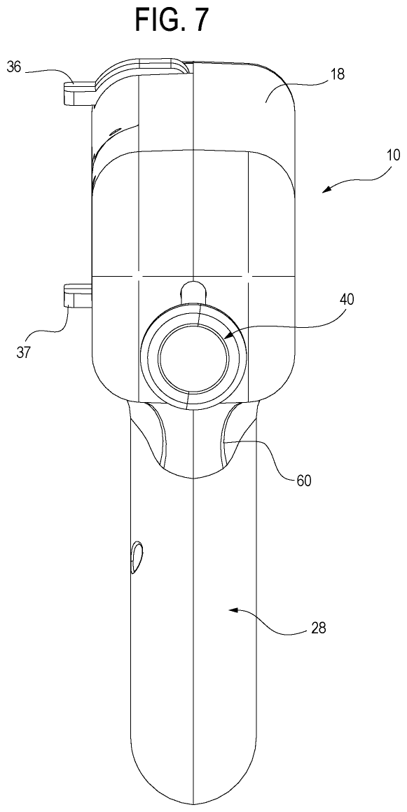

Referring initially to FIGS. 1-7, an exemplary handheld, hand-operated dispensing system (referred to herein as a dispensing system or the dispensing system for purposes of brevity) for dispensing soft edibles and medications in the form of soft pet food, soft pet treats, pastes, medications of a specific viscosity, edible medication mixtures, or pâté-like substances is shown. While the dispensing system is intended primarily for dispensing controlled portions of edibles for pets, by way of example and not of limitation, it may also be used in cooking, baking, and other applications for dispensing substances having viscosities suitable for dispensation by the dispensing system without clogging it up. As will be described in greater detail below, the dispensing system applies controlled dispensing technology to soft edibles, namely, pet food and treats, optimizing portion control, mess-free handling, and hygienic feeding and provides precise portioning, easy one-handed operation, and a sealed pouch system for convenience and cleanliness, features very appealing to pet owners, trainers, and veterinarians.

In the embodiment of FIGS. 1-8A and 8B, the dispensing system 10 includes a reusable handgun or pistol-shaped dispenser body 15 having an elongated, rectangular-shaped upper body portion 18, including an internal cavity or chamber 20 adapted to house a sealed, flexible pouch 25 containing soft pet edibles or medications, the dispenser body and internal cavity or chamber extending coaxially about a longitudinal axis A-A, and a handle 28 extending radially outward from the handgun or pistol-shaped dispenser body. The handle includes a contoured grip 32 with optional rubberized or textured surfaces 34 and/or finger grooves for improved comfort and usability, a trigger 38 operatively connected to a plunger or advancement mechanism shown generally at 40 adapted to controllably dispense the contents of the sealed, flexible pouch 25 via a dispensing aperture 26 formed in a first end 27 of the flexible pouch. The comfort grip enhances user control and reduces hand fatigue, making it easy to use even with a gloved hand and further includes a curvilinear trigger guard 45 operatively connected at a first end 48 thereof to the contoured grip 32 and at a second end 50 to the elongated, rectangular-shaped upper body portion 18. The curvilinear trigger guard cooperates with the contoured grip 32 of the handle 28 in enhancing user control and also to prevent activation of the plunger or advancement mechanism 40 via unintentional depression of the trigger 38 should the dispensing system be accidentally dropped.

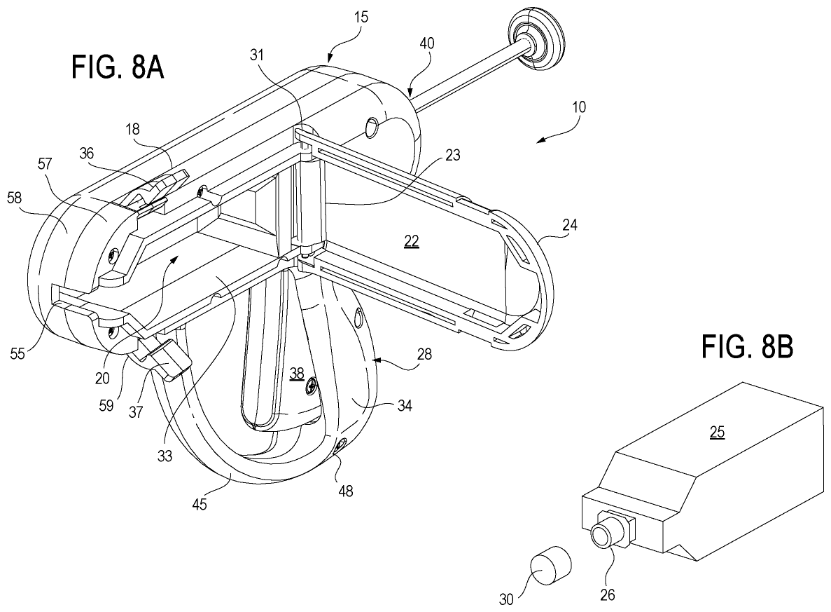

In the embodiment shown, the dispensing aperture of the pouch includes a removable cap 30 adapted to prevent leakage, contamination, or drying out of the soft pet edibles or medications contained therein; however, it is to be understood that sealed, flexible pouches may be formed of foil or synthetic materials having tear-off tips, twist-off tops, or pre-cut openings for controlled dispensing of content without departing from the scope of the instant invention. When the sealed, flexible pouch 25 is removably positioned in the internal cavity or chamber 20, the dispensing aperture 26 is aligned with a dispensing port or nozzle 55 formed in a first end 58 of the elongated, rectangular-shaped upper body portion 18 whereby smooth and mess-free extrusion of soft pet food and treats in response to activation of the plunger or advancement mechanism 40 is ensured. As best viewed in FIG. 8A, the elongated, rectangular-shaped upper body portion 18 of the reusable handgun or pistol-shaped dispenser body 15 further includes a side panel 22 pivotally connected at a first end 23 thereof by hinge 31 to the pistol-shaped dispenser body which, when opened, creates an aperture 33 via which the sealed, flexible pouches may be placed in or removed from the internal cavity or chamber 20. The side panel 22 is releasably secured at a second end 24 thereof in a secured closed position by first and second opposed clasps 36, 37 operatively connected to respective top and bottom portions 57, 59 of the elongated, rectangular-shaped upper body portion 18. The chamber itself is fixed in size, but the plunger adjusts to accommodate different pouch capacities which are available in multiple sizes, including compact, standard, and high-capacity versions, all specifically designed to store soft edibles and medications in the form of soft pet food, soft pet treats, pastes, or pâté-like food substances.

Referring again to FIGS. 1-3, the dispensing system 10 has an eyelet 60 operatively connected to or formed integrally with the elongated, rectangular-shaped upper body portion 18, the eyelet being adapted to receive a lanyard or other suitable means for securing the dispensing system to a user's wrist, belt, back or fanny pack and the like. The dispensing system may also include other portability features, by way of example and not of limitation, an integrated belt clip, holster attachment, or hand loop, enabling hands-free carrying during training or outdoor activities.

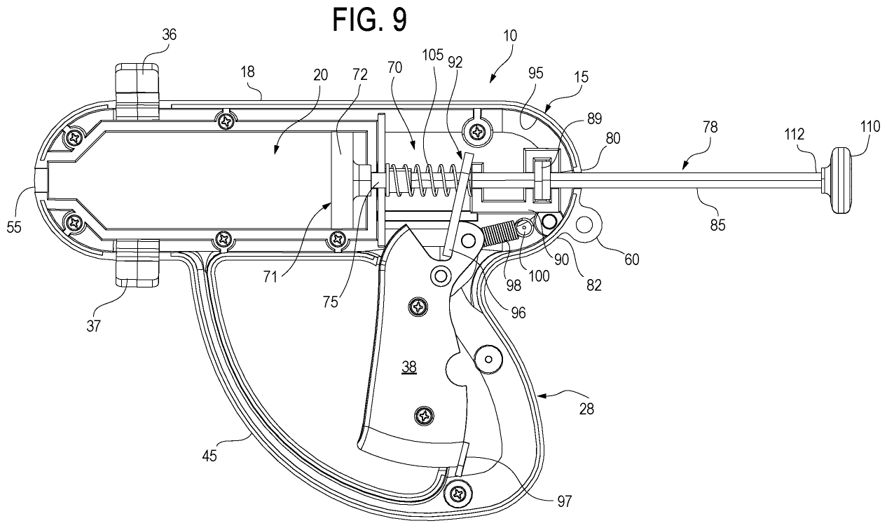

Different embodiments of the manual plunger or advancement mechanism shown generally at 40 in FIGS. 1-5 and 7 are depicted in FIGS. 9-15A and 15B. Referring initially to FIG. 9, a manual plunger advancement mechanism is shown in the form of a friction-based clutch system 70 in accordance with an embodiment of the present invention. The friction-based clutch system includes a plunger assembly 71 having a plunger 72 positioned in the chamber 20 and operatively connected to the first end 75 of rod 78 which extends coaxially along longitudinal axis A-A shown in FIG. 1 into the chamber 20 via an aperture 80 formed in a second end 82 of the elongated, rectangular-shaped upper body portion 18. The rod has a smooth outer surface 85 supported by a friction-based clutch system 89 mounted in a support bracket 90 operatively connected to an inner surface 95 of the elongated, rectangular-shaped upper body portion 18. The rod 78, the plunger assembly 71, and the plunger 72 are urged into compressive engagement with a pouch 25 when it is positioned in the chamber 20 in response to a force transferred from the trigger 38 when actuated by a user by a connector member 92 operatively secured at a first end 94 thereof to the rod and at a second end 96 thereof to the trigger 38. When the trigger is released, it is returned to a released position limited by a stop member by forces exerted by spring 98 connected at a first end 100 thereof to the inner surface 95 of the elongated, rectangular-shaped upper body portion 18 and at a second end 102 to the trigger. A spring 105 positioned over the rod urges the connector member 92 back to its starting position in contact with the friction-based clutch system 89 which, at the same time, maintains the rod 78, the plunger assembly 71, and the plunger 72 in compressive engagement with the pouch. Selective movement of the trigger translates into controlled movement of the plunger which, in turn, translates into controlled dispensing of the contents of the pouch. A knob 110 secured to a second end 112 of the rod may be grasped by a user to pull the rod, the plunger assembly and the plunger in a direction opposite the direction in which the plunger moved into compressive engagement with the pouch, whereby the pouch may be removed from the chamber when it is empty or when a pouch having different contents is selected.

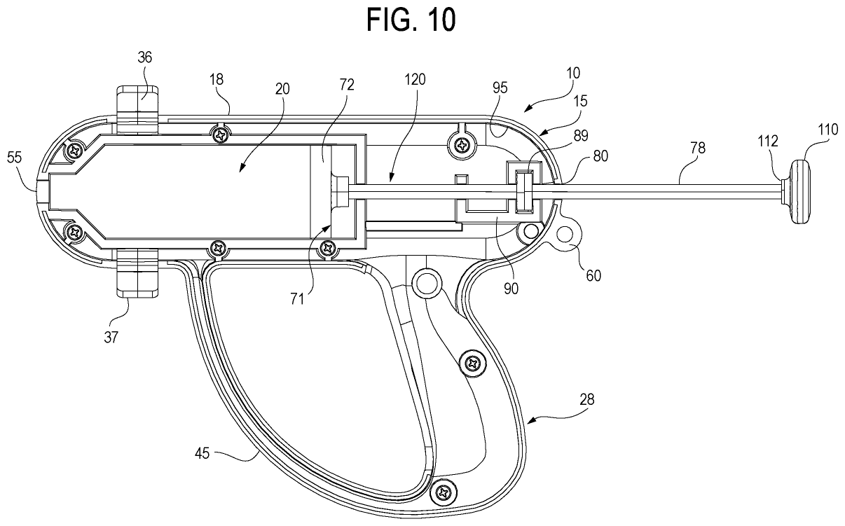

FIG. 10 illustrates the components of a manual plunger advancement mechanism in the form of a palm press assembly 120 in accordance with an embodiment of the present invention. Similar in construction to the friction-based clutch system of FIG. 9, the palm press assembly is supported by a friction-based clutch system 89 mounted in a support bracket 90 operatively connected to an inner surface 95 of the elongated, rectangular-shaped upper body portion 18. The smooth rod 78 extends coaxially along longitudinal axis A-A shown in FIG. 1 into the chamber 20 via an aperture 80 formed in a second end 82 of the elongated, rectangular-shaped upper body portion 18. The smooth rod, the plunger assembly 71, and the plunger 72 are urged into compressive engagement with a pouch 25 when it is positioned in the chamber 20 in response to a force transferred by a user when applied to a knob 110 secured to a second end 112 of the rod. The knob may be grasped by a user to pull the rod, the plunger assembly and the plunger in a direction opposite the direction in which the plunger moved into compressive engagement with the pouch, whereby the pouch may be removed from the chamber when it is empty or when a pouch having different contents is selected.

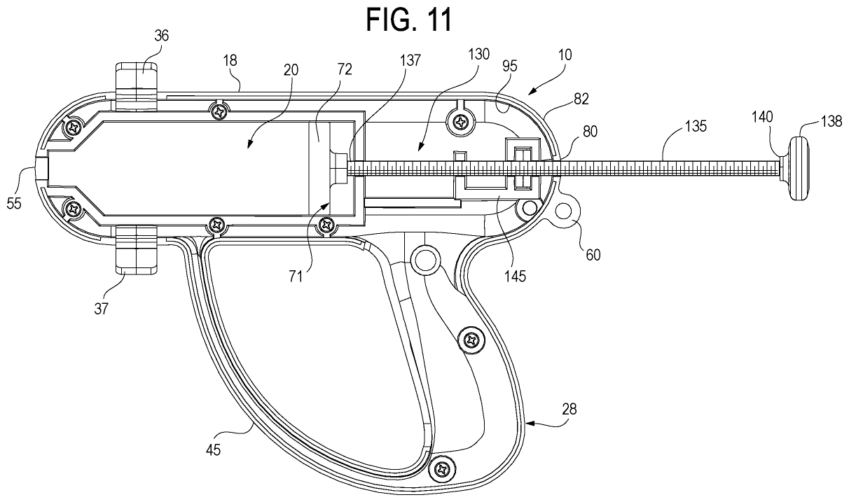

FIG. 11 illustrates the components of a manual plunger advancement mechanism in the form of a twist knob assembly 130 in accordance with an embodiment of the present invention. The twist knob assembly includes a threaded rod 135 extending coaxially along longitudinal axis A-A shown in FIG. 1 into the chamber 20 via an aperture 80 formed in a second end 82 of the elongated, rectangular-shaped upper body portion 18. The twist knob assembly includes a plunger assembly 71 having a plunger 72 positioned in the chamber 20 and operatively connected to a first end 137 of the threaded rod and a knob 138 operatively connected to a second end 140 thereof. The twist knob assembly is supported by a support bracket 145 operatively connected to an inner surface 95 of the elongated, rectangular-shaped upper body portion 18. In operation, the threaded rod, the plunger assembly 71, and the plunger 72 are urged into compressive engagement with a pouch 25 when it is positioned in the chamber 20 in response to a rotational force applied by a user in a clockwise direction to the knob. To retract the threaded rod, the plunger assembly, and the plunger, a user simply applies a rotational force to the knob in a counterclockwise direction.

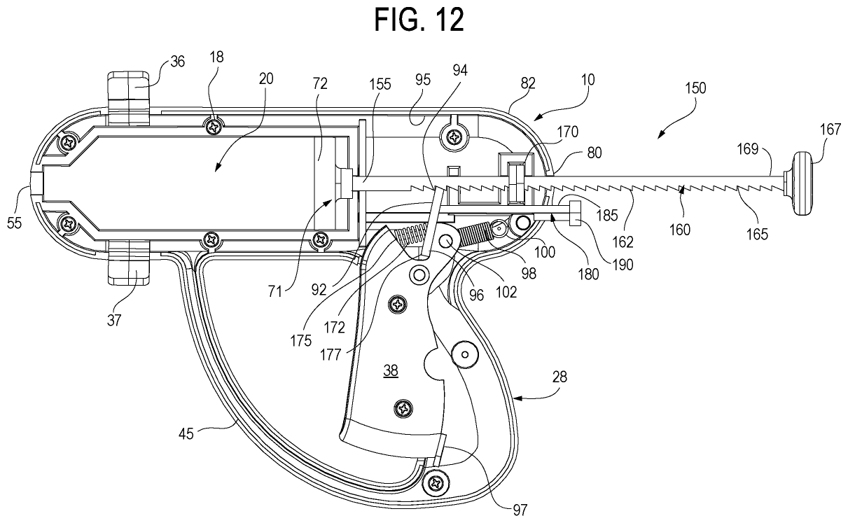

The components of a ratchet and pawl manual plunger advancement mechanism 150 are shown in FIG. 12. Similar to the elements of the hereinabove described advancement mechanisms, the ratchet and pawl manual plunger advancement mechanism 150 includes plunger assembly 71 having a plunger 72 positioned in the chamber 20 and operatively connected to a first end 155 of a rod 160 having a plurality of ratchet teeth 162 formed on and extending along a bottom surface 165 thereof. A knob 167 is operatively connected to a second end 169 of the rod 160, which extends coaxially along longitudinal axis A-A shown in FIG. 1 into the chamber 20 via an aperture 80 formed in a second end 82 of the elongated, rectangular-shaped upper body portion 18. The ratchet and pawl assembly is supported by a support bracket 170 operatively connected to an inner surface 95 of the elongated, rectangular-shaped upper body portion 18. The rod 160, the plunger assembly 71, and the plunger 72 are urged into compressive engagement with a pouch 25 when it is positioned in the chamber 20 in response to a force transferred from the trigger 38 when actuated by a user by a connector member 92 operatively secured at a first end 94 thereof to at least one of the plurality of ratchet teeth 162 formed on and extending along a bottom surface 165 of the rod and at a second end 96 thereof to the trigger 38. When the trigger is released, it is returned to a released position limited by stop member 97 by forces exerted by a spring 98 connected at a first end 100 thereof to the inner surface 95 of the elongated, rectangular-shaped upper body portion 18 and at a second end 102 to the trigger. A second spring 172 operatively connected at a first end 175 thereof to the trigger and at a second end thereof 177 to the connector member 92 maintains the connector member 92 in active engagement with at least one of the plurality of ratchet teeth 162 formed on and extending along a bottom surface 165 of the rod. To disengage the connector member from active engagement with at least one of the plurality of ratchet teeth, a pawl 180 extending via aperture 185 formed in the second end 82 of the elongated, rectangular-shaped upper body portion 18 and operatively connected at a first end 187 thereof to the connector member is withdrawn from the second end of the elongated, rectangular-shaped upper body portion 18 by a user by grasping a knob 190 formed on a second end 192 of the pawl. The second spring 172 urges the connector member into a disengaged position with respect to the at least one of the plurality of ratchet teeth 162 formed on and extending along a bottom surface 165 of the rod, and the user may withdraw the rod by grasping the knob 167 and pulling the rod, the plunger assembly and the plunger in a direction opposite the direction that the plunger moved into compressive engagement with the pouch, whereby the pouch may be removed from the chamber when it is empty or when a pouch having different contents is selected.

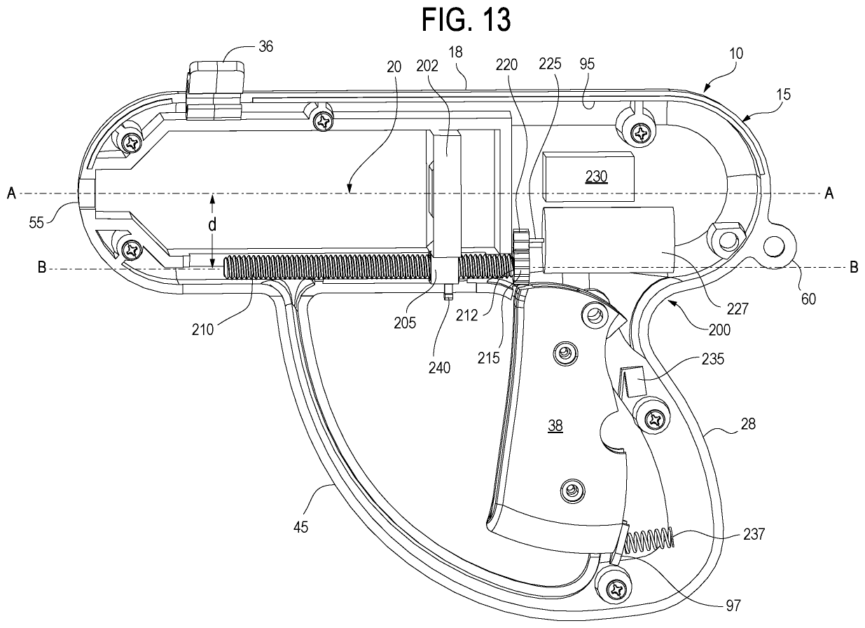

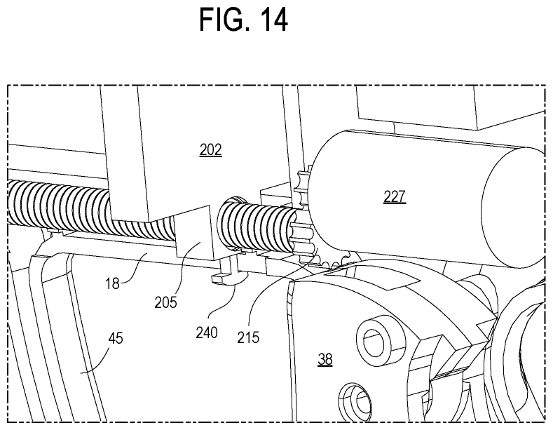

FIGS. 13 and 14 illustrate the components of a manual plunger advancement mechanism in the form of an electrically powered lead screw system 200 in accordance with an embodiment of the present invention. The electrically powered lead screw system includes a plunger or pressure plate 202 positioned in the chamber 20 and operatively connected at a first end 205 thereof to a lead screw 210 having a longitudinal axis B-B extending in a direction parallel to but offset by a preselected distance d from the axis A-A. The lead screw includes a first end 212 having a first gear 215 secured thereto, the first gear being in operative engagement with a second gear 220 secured to the output shaft 225 of motor 227. The motor is electrically powered by energy received from a battery 230 mounted to an inner surface 95 of the elongated, rectangular-shaped upper body portion 18 and is actuated when the trigger 38 is depressed by a user which engages a momentary switch 235 that is normally in an “off” position. When the trigger is released, it is urged back into the released position limited by stop member 97 by a spring 237, and the momentary switch returns to the “off” position, thereby shutting off the motor and stopping compressive movement of the plunger or pressure plate 202, which stops dispensing the contents of the pouch. Once the plunger or pressure plate reaches the end of its travel, a button 240 operatively connected to the pressure plate engages the elongated, rectangular-shaped upper body portion 18, which forces the button and the pressure plate to move in an upward direction. This upward movement disengages the plunger or pressure plate from the lead screw so that the plunger or pressure plate may be pushed back manually to its initial position.

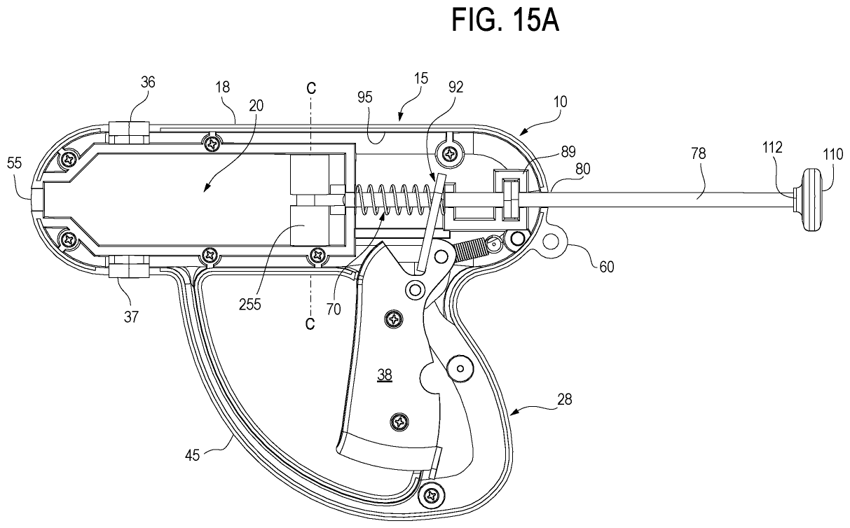

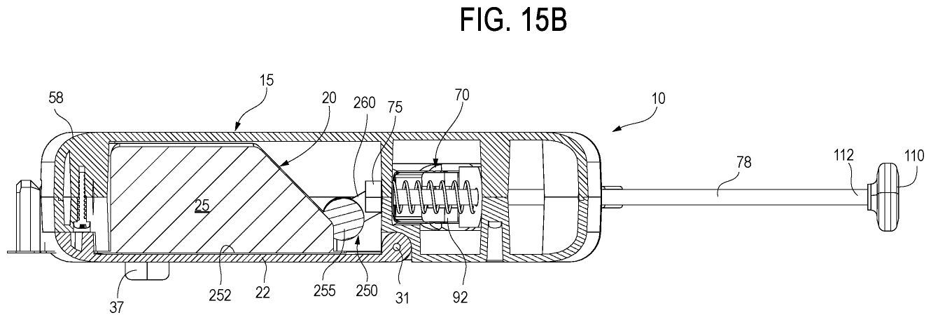

FIGS. 15A and 15B show the details of the handheld, hand-operated dispensing system for dispensing soft edibles and medications having a manual plunger advancement mechanism in the form of the friction-based clutch system shown in FIG. 9, the operation of which is described above. However, in the embodiment of FIGS. 15A and 15B, the manual plunger advancement mechanism is operatively connected to a roller-based pouch compression system 250 instead of to the plunger assembly 71 and plunger 72. The roller-based pouch compression system includes a roller 255 which is rotatable about a central axis C-C that is oriented perpendicularly to the axis A-A shown in FIG. 1 and vertically positioned in the chamber 20 in contact with an inner surface 252 of the side panel 22 and in compressive engagement with the pouch. The roller is operatively connected to the first end 75 of the rod 78 via a link member 260 which extends coaxially along longitudinal axis A-A into the chamber 20 via an aperture 80 formed in a second end 82 of the elongated, rectangular-shaped upper body portion 18. In operation, a user's selective movement of the trigger translates into controlled movement of the roller 255 which, in turn, translates into controlled dispensing of the contents of the pouch. A knob 110 secured to a second end 112 of the rod may be grasped by a user to pull the rod and the roller in a direction opposite the direction in which the roller moved into compressive engagement with the pouch, whereby the pouch may be removed from the chamber when it is empty or when a pouch having different contents is selected.

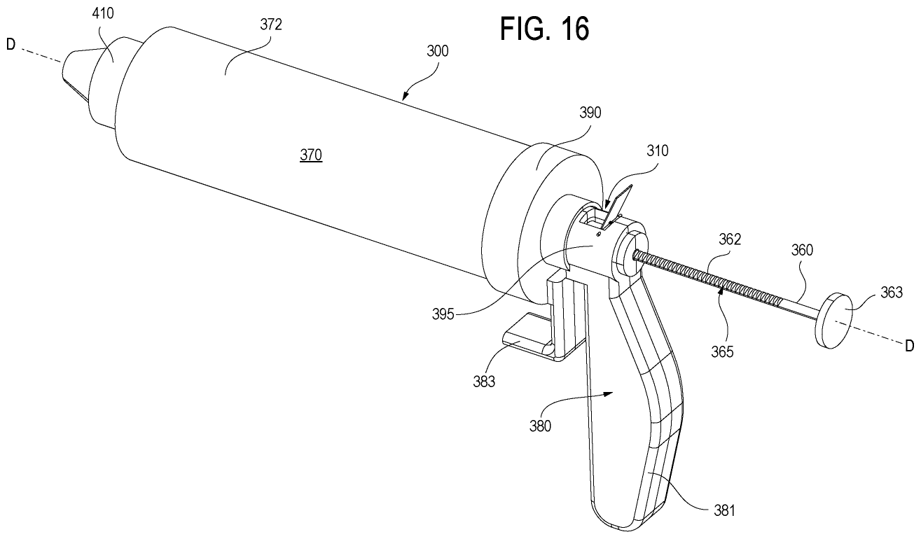

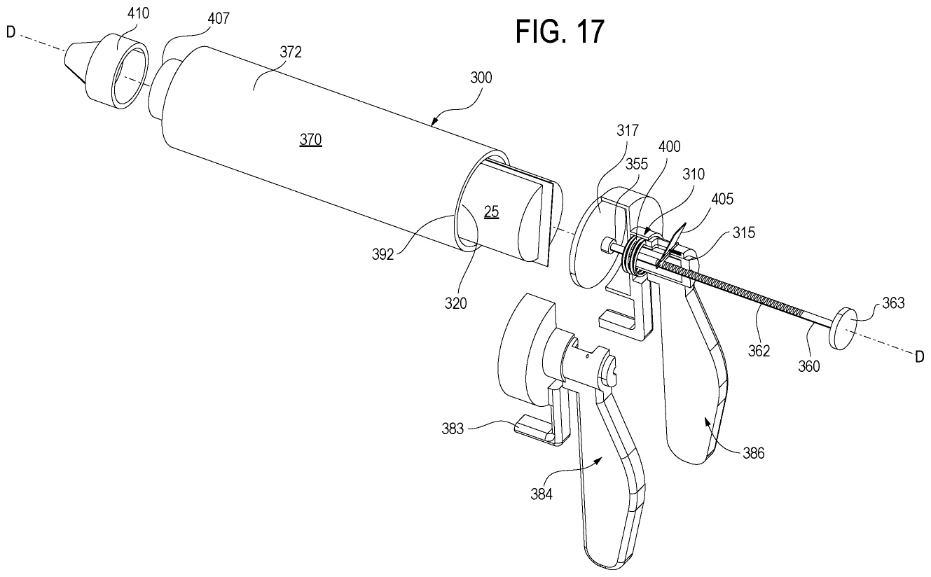

Referring now to FIGS. 16 and 17, the details of a handheld, hand-operated dispensing system 300 for dispensing soft edibles and medications having a ratcheting manual plunger advancement mechanism 310 are depicted. In the embodiment shown, the handheld, hand-operated dispensing system 300 includes a cylindrically-shaped dispenser 370 having a tubular body portion 372 extending along and circumferentially about axis D-D and forming a cylindrical cavity or chamber 320 therein. The ratcheting manual plunger advancement mechanism 310 includes a plunger assembly 315 having a plunger 317 positioned in the chamber 320 and operatively connected to a first end 355 of a rod 360. The rod has a plurality of ratchet teeth 362 formed thereon and extending circumferentially about and longitudinally along a surface 365 thereof and a knob 363 operatively connected to a second end 364 of the rod.

As best seen in FIG. 17, the dispensing system further includes a handle assembly 380 formed by two body portions 384, 386, each being the mirror image of the other. The handle assembly includes an end cap 390 adapted to fit over a first end 392 of the cylindrically-shaped dispenser 370 and a tubular housing portion 395 adapted to contain the ratcheting manual plunger advancement mechanism 310, referred to hereinafter as the plunger or dispensing mechanism 310. The plunger mechanism includes a cylindrical guide member 400 adapted to receive and guide the rod 360 and a plurality of ratchet teeth 362 formed thereon release member or pawl 405 adapted to be releasably engaged with at least one of the plurality of ratchet teeth 362 formed on the rod 360. A nozzle or dispensing port 407 is formed in a second end 398 of the cylindrically-shaped dispenser 370 and extends uniformly circumferentially around the axis D-D. The nozzle or dispensing port 407 provides controlled dispensing of the contents of the pouch which is inserted into the cylindrically-shaped dispenser 370 with a dispensing aperture formed therein in alignment with the nozzle or dispensing port 407 and accommodates interchangeable dispensing tip attachments, for example tip 410, for varied dispensing needs, thus ensuring smooth and mess-free extrusion. The interchangeable dispensing tip attachments may be constructed from either rigid or softer materials to be gentle on pets'teeth and gums, and of soft pet food, treats, and medications. The nozzle's internal geometry and the food's viscosity prevent excessive dripping, and a removable storage cap may be used to cover and protect the nozzle.

The handle assembly 380 is configured to allow for pouch replacement, and may include a screw-off mechanism or other attachment methods such as a snap-fit or sliding mechanism. Designed for single-hand operation, it features an ergonomic grip 381 with optional finger grooves or non-slip rubberized surfaces and a finger rest 383 upon which a user may place his or her trigger or index finger for enhanced dispensing control during operation of the dispensing system.

In operation, a user grasps the handle assembly 380 and ergonomic grip 381 and pushes on the knob 363 operatively connected to the second end 364 of the rod 360, thereby urging the plunger 317 into compressive engagement with a pouch 25 when it is positioned in the chamber 320. By carefully selecting the amount of movement of the rod and the plunger, the user may dispense a precise amount of the contents of the pouch. When the pouch is empty or in the situation where a user wishes to change the deliverables by inserting a different pouch into the chamber, the user may simply disengage the release member or pawl 405 from the ratchet teeth and pull the rod and the plunger in a direction opposite the direction in which they moved into compressive engagement with the pouch, whereby the pouch may be removed from the chamber when it is empty or when a pouch having different contents is selected.

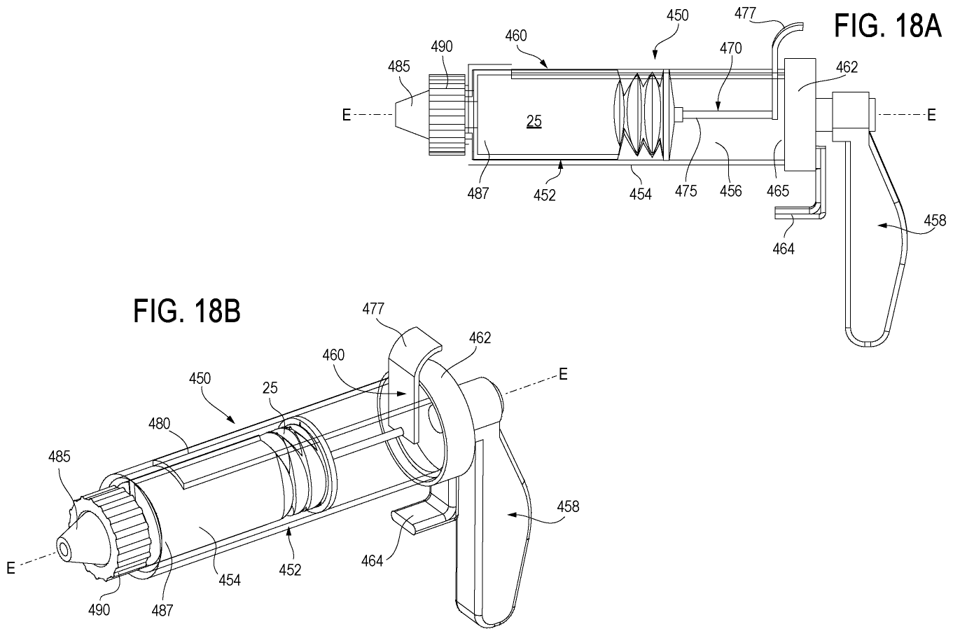

Referring now to FIGS. 18A and 18B, the features of a handheld, hand-operated dispensing system 450 for dispensing soft edibles and medications having a slider-based advancement mechanism 460 are shown. The handheld, hand-operated dispensing system 450 includes a cylindrically-shaped dispenser 452 having a tubular body portion 454 extending along and circumferentially about longitudinal axis E-E and forming a cylindrical cavity or chamber 456 therein. The dispensing system further includes a handle assembly 458 operatively connected to an end cap 462 adapted to fit over a first end 465 of the cylindrically-shaped dispenser 452 and a finger rest 464. A slider advancement system 470 has a plunger 472 positioned in the cylindrical cavity or chamber 456 and operatively connected via rod 475 to a slider handle or lever 477 which extends radially outward from the cylindrically-shaped dispenser 452 via a slot 480 formed in the tubular body portion 454.

In operation, a user grasps the handle assembly 458 and pushes on the slider handle or lever 477 operatively connected to the rod 475, thereby urging plunger 472 into compressive engagement with a pouch 25 when it is positioned in the chamber 320. A controlled amount of the contents of the pouch, i.e., soft pet food, pet treats, medications or a combination thereof, are dispensed via the nozzle 485 secured to a second end 487 of the cylindrically-shaped dispenser by a retention collar 490. When the pouch is empty or in the situation where a user wishes to change the deliverables by inserting a different pouch into the chamber, the user may simply pull the slider handle or lever 477, the rod and the plunger in a direction opposite the direction in which they moved into compressive engagement with the pouch, whereby the pouch may be removed from the chamber when it is empty or when a pouch having different contents is selected.

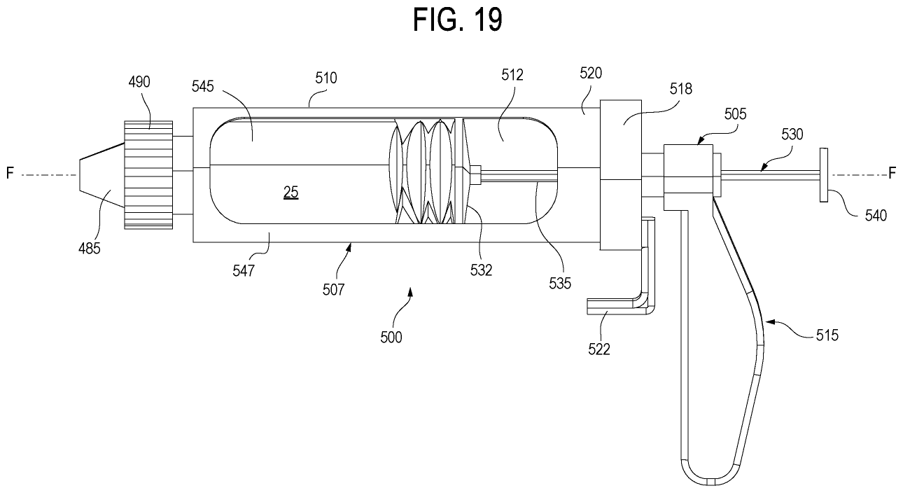

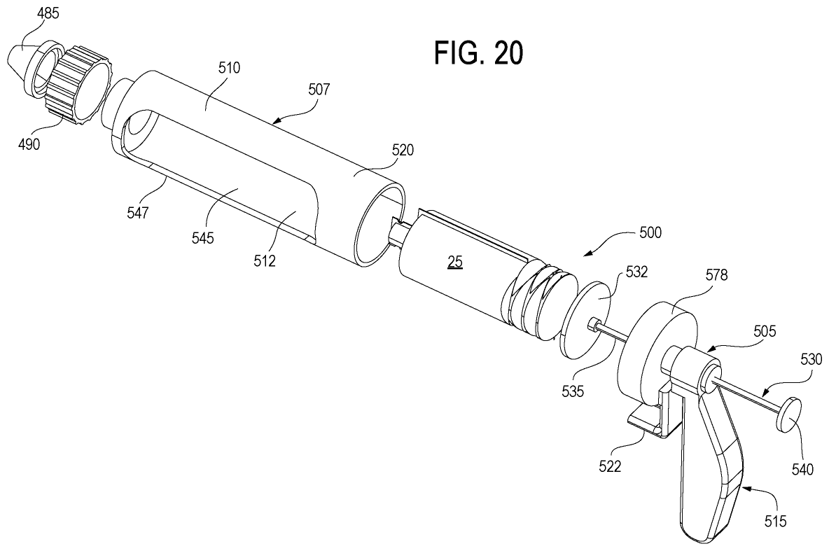

The elements of a side load handheld, hand-operated dispensing system 500 for dispensing soft edibles and medications having a manual plunger advancement mechanism in the form of a palm press assembly 505 are shown in FIGS. 19 and 20. Similar in construction and operation to embodiment shown in FIGS. 18A and 18B, side load embodiment includes a cylindrically-shaped dispenser 507 having a tubular body portion 510 extending along and circumferentially about longitudinal axis F-F and forming a cylindrical cavity or chamber 512 therein. The dispensing system further includes a handle assembly 515 operatively connected to an end cap 518 adapted to fit over a first end 520 of the cylindrically-shaped dispenser 507 and a finger rest 522. A palm press advancement system 530 has a plunger 532 positioned in the cylindrical cavity or chamber 512 and operatively connected via a rod 535 to a palm press knob 540. In this embodiment, replaceable pouches containing edibles or medications for pets are easily loaded and unloaded into and from the cylindrical cavity or chamber 512 via aperture or port 545 formed in a side portion 547 of the cylindrically-shaped dispenser 507.

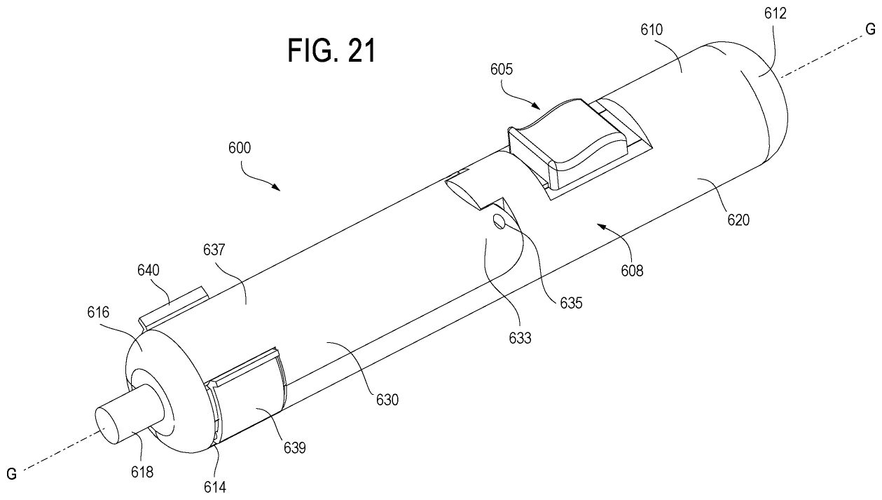

The feature of a handheld, hand-operated dispensing system 600 for dispensing soft edibles and medications having a thumb-actuated advancement mechanism 605 are illustrated in FIGS. 21-23. The hand-operated dispensing system 600 has an elongated cylindrically-shaped body 608 extending circumferentially about and along a longitudinal axis G-G, the cylindrically-shaped body having a first end portion 610 closed by a first end cap 612, and closed by a second end cap 616, the second end cap having a dispensing tube 618 disposed therein and extending along and circumferentially about the longitudinal axis G-G. The elongated cylindrically-shaped body 608 includes a sidewall 620 extending intermediate the first and second end caps, the sidewall and the end caps co-operating to form a chamber or cavity 622 in the cylindrically-shaped body, the chamber being adapted to receive and house a replaceable pouch 625 for storing and dispensing edibles and medications for pets and to house elements of the thumb-actuated advancement mechanism 605. The cylindrically-shaped body further includes a closure member or lid 630 covering an aperture 631 formed in the cylindrically-shaped body and adapted to provide access to the chamber or cavity 622. The closure member or lid 630 is pivotally connected to the sidewall 620 at a first end 633 thereof by a hinge member 635 and is releasably secured at a second end 637 thereof to the cylindrically-shaped body by a pair of clips or fasteners 639, 640.

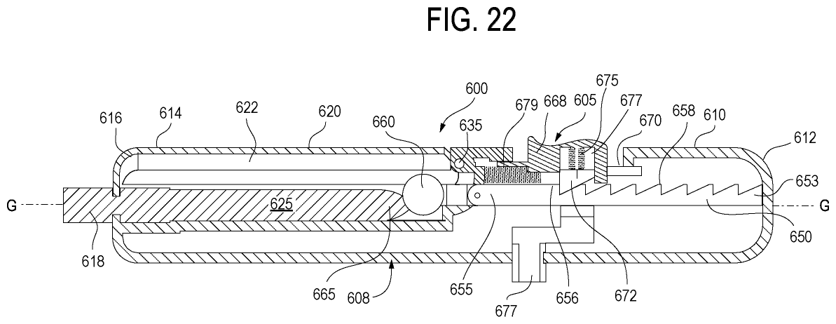

In the embodiment of FIG. 22, the thumb-actuated advancement mechanism 605 is in the form of a ratchet mechanism having an elongated ratchet rod 650 operatively positioned in the cavity 622 and oriented in a direction which is parallel to the longitudinal axis G-G. The ratchet rod includes a first end 653 positioned at the first end portion 610 of the cylindrically-shaped body 608, a second end 655 located below the hinge 635, an upper surface 656 extending intermediate the first and second ends, the upper surface having a plurality of ratchet teeth 658 formed thereon and extending outward therefrom. A compression roller 660 is pivotally connected to the second end of the ratchet rod positioned adjacent a sealed first end 665 of the replaceable pouch 625. A thumb-actuating button 668 is slidably positioned in an aperture 670 formed in the sidewall 620 and includes a tooth member 672 extending downward therefrom and urged into operating engagement with plurality of ratchet teeth 658 by one or more springs 675 positioned in a cavity formed in the thumb-actuating button.

In operation, a user slides the thumb-actuating button in a direction toward the second end portion 614 of the elongated cylindrically-shaped body 608, thereby urging the roller onto the replaceable pouch 625 and in compressive engagement therewith, the force of which dispenses a controlled amount of the contents of the replaceable pouch through the dispensing tube 618. The dispensing movement of the thumb-actuating button may be repeated as needed by depressing a release button 677 which disengages the tooth member 672, thus allowing the thumb-actuating button to move in a direction opposite the dispensing direction in response to forces exerted thereon by a return spring 679. When the pouch is empty or in the situation where a user wishes to change the deliverables by inserting a different pouch into the chamber, the user may simply open the closure member or lid 630 whereby the pouch may be removed from the chamber when it is empty or when a pouch having different contents is selected.

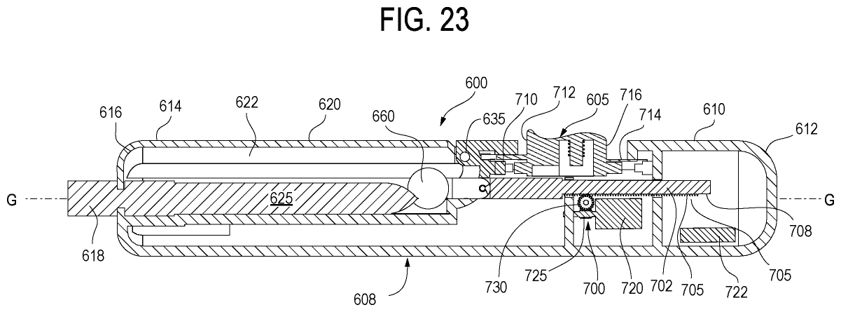

In the embodiment of FIG. 23, the thumb-actuated advancement mechanism 605 is in the form of a rack and pinion gear system 700 which includes a rack member 702 having a plurality of gear teeth 705 formed on or operatively connected to a bottom surface 708 thereof. The rack is adapted to move either toward the first end portion or the second end portion of the elongated cylindrically-shaped body 608 in response to selective movement of the thumb-actuating button 668 in the desired direction. A first momentary switch 710 is positioned adjacent a first side 712 of the thumb-actuating button, and a second momentary switch 714 is positioned adjacent a second side 716 of the thumb-actuating button. Selective directional movement of the thumb-actuating button loses one or the other of the momentary switches in response to which an electric motor 720 powered by battery 722 rotates in the desired direction, whereby a worm gear 725 operatively connected to the motor output shaft and in operative engagement with pinion gear 730 drives the rack and roller onto the replaceable pouch 625 and in compressive engagement therewith, the force of which dispenses a controlled amount of the contents of the replaceable pouch through the dispensing tube 618. The dispensing movement of the thumb-actuating button may be repeated as needed. When the pouch is empty or in the situation where a user wishes to change the deliverables by inserting a different pouch into the chamber, the user may simply move the thumb-actuating button in the opposite direction to retract the roller, open the closure member or lid 630, and remove the pouch from the chamber when it is empty or when a pouch having different contents is selected.

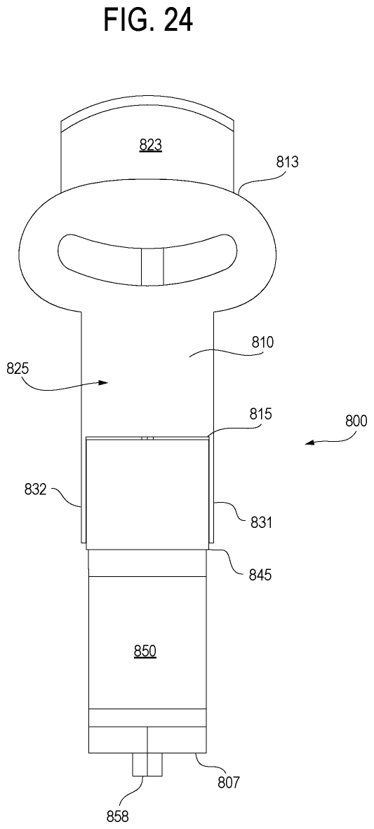

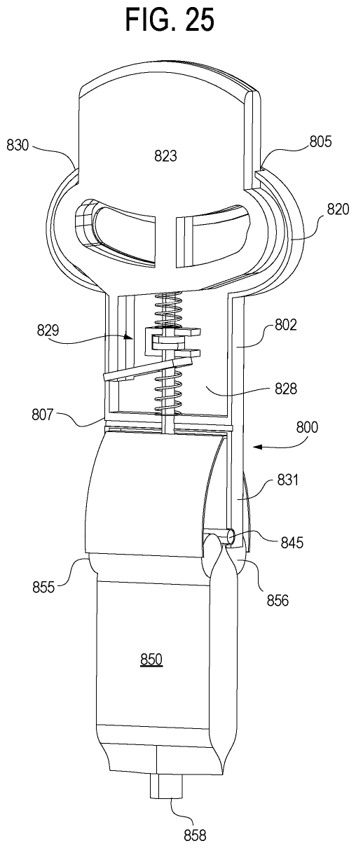

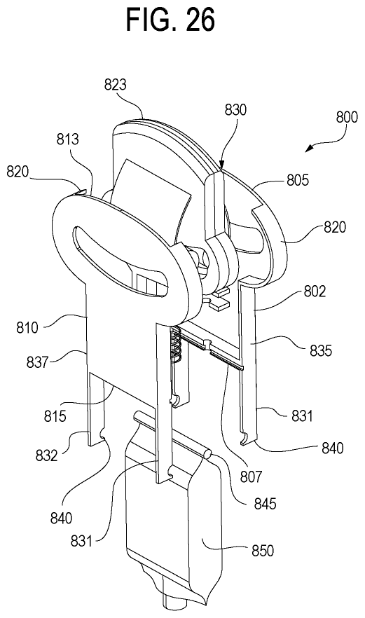

The features of a palm press-actuated handheld, hand-operated dispensing system 800, referred to herein as simply the palm press assembly, for dispensing soft edibles and medications are illustrated in FIGS. 24, 25, and 26. The palm press assembly includes a first key-shaped plate or tray member 802 having a first flat or open end 805 and a second closed end 807 and a second key-shaped plate or tray member 810 also having a corresponding first flat or open end 813 and a second closed end 815. As best shown in FIG. 25, each of the key-shaped tray members includes a raised edge portion, one of which is shown at 820 in FIG. 25, extending along the left side, the right side, and the second closed end. When the key-shaped plates or tray members are connected with the respective raised edge portions in contact with each other, they cooperate to form a handle 825 (FIG. 24) having a cavity 828 therein and an aperture 830 defined by the flat or open ends, the aperture and the cavity being adapted to slidably receive a palm-actuating member 823 and spring-actuating mechanism 829 therein. Each of the key-shaped plates or tray members further includes a pair of spaced-apart arms 831 and 832 extending from the right and left sides 835, 837 below the respective second closed ends. Each of the arms has a notch 840 formed therein adapted to receive a sealed end portion 845 of a replaceable pouch 850.

In operation, when a user depresses the palm-actuating member 823, a pair of opposing rollers 855, 856 are urged into compressive engagement with the replaceable pouch 850, the force of which dispenses a controlled amount of the contents of the replaceable pouch through a dispensing tube 858. The dispensing movement of the palm-actuating member may be repeated as needed.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents.

What is claimed is:

1. A handheld, hand-operated dispensing system for dispensing soft pet food, soft pet treats, pastes, medications of a specific viscosity, edible medication mixtures, or pâté-like substances in indoor household environments and during outdoor field training and handling activities comprising:
a sealed, disposable, flexible pouch containing soft pet food, soft pet treats, pastes, medications of a specific viscosity, edible medication mixtures, or pâté-like substances;
a reusable handheld dispenser body having an internal chamber adapted to house the sealed, disposable, flexible pouch containing soft pet food, soft pet treats, pastes, medications of a specific viscosity, edible medication mixtures, or pâté-like substances; and
a dispensing mechanism adapted to deliver a controlled portion of the soft pet food, soft pet treats, pastes, medications of a specific viscosity, edible medication mixtures, or pâté-like substances contained in the sealed, disposable, flexible pouch.

2. The handheld, hand-operated dispensing system of claim 1 wherein the reusable handheld dispenser includes a handgun-shaped dispenser body having an elongated, rectangular-shaped upper body portion and wherein the internal chamber adapted to house the sealed, disposable, flexible pouch is located in the elongated, rectangular-shaped upper body portion of the handgun-shaped dispenser body.

3. The handheld, hand-operated dispensing system of claim 2 wherein the elongated, rectangular-shaped upper body portion and the internal chamber located therein extend coaxially along a longitudinal axis.

4. The handheld, hand-operated dispensing system of claim 3 further including a handle or grip portion extending radially outward from the elongated, rectangular-shaped upper body portion.

5. The handheld, hand-operated dispensing system of claim 4 wherein the handgun-shaped dispenser body includes a handle or grip portion.

6. The handheld, hand-operated dispensing system of claim 5 wherein the handle or grip portion is an ergonomic handle or grip contoured to fit a human hand.

7. The handheld, hand-operated dispensing system of claim 6 wherein the ergonomic handle or grip has a rubberized coating or textured surface.

8. The handheld, hand-operated dispensing system of claim 7 wherein the dispensing mechanism is a friction-based clutch system.

9. The handheld, hand-operated dispensing system of claim 7 wherein the dispensing mechanism is a ratchet-and-pawl mechanism.

10. The handheld, hand-operated dispensing system of claim 7 wherein the dispensing mechanism is an electrically powered lead screw system.

11. The handheld, hand-operated dispensing system of claim 7 wherein the dispensing mechanism is a slider-based advancement system.

12. The handheld, hand-operated dispensing system of claim 7 wherein the dispensing mechanism is a manual twist or lead screw based advancement system.

13. The handheld, hand-operated dispensing system of claim 7 wherein the dispensing mechanism is a roller-based compression system.

14. The handheld, hand-operated dispensing system of claim 7 wherein the dispensing mechanism is a battery powered lead screw system.

15. The handheld, hand-operated dispensing system of claim 2 further including a nozzle or dispensing port adapted to provide controlled dispensing of soft edibles and medications.

16. The handheld, hand-operated dispensing system of claim 14 wherein the nozzle or dispensing port further includes one or more interchangeable tip attachments.

17. The handheld, hand-operated dispensing system of claim 1 wherein the reusable handheld dispenser body is in the shape of a cupcake syringe or a calk gun.

18. The handheld, hand-operated dispensing system of claim 1 wherein the sealed, disposable, flexible pouch is a heat-sealed, flexible foil or plastic pouch having a tear-off tip, a twist-off top, or a pre-cut opening for controlled dispensing of the soft pet edibles, medications, or soft pet edible medication mixtures contained therein.
